(19) United States
(12) Patent Application Publication
(10) Pub. No.: US 2026/0318335 A1
(43) Pub. Date: Oct. 15, 2026

(54) HARNESS ASSEMBLY FOR A REFRIGERATOR APPLIANCE

(71) Applicant: Haier US Appliance Solutions, Inc., Wilmington, DE (US)

(72) Inventors: Daniel Roth, Evansville, IN (US); Gopi Krishna Chowdary Vulava, Louisville, KY (US)

(21) Appl. No.: 19/174,238

(22) Filed: Apr. 9, 2025

(51) Int. Cl. F25D 23/06; H02G 3/04; H02G 3/32

(52) U.S. Cl. CPC F25D 23/062; F16L 3/123; H02G 3/0481; H02G 3/32

(57) ABSTRACT

A refrigerator appliance includes a cabinet and a conduit coupled with the cabinet. A liner is disposed within the cabinet. A harness assembly includes a tab coupled with the conduit and extends therefrom. The tab defines at least one aperture. The tab includes at least one shoulder that extends vertically down from the tab. A connection feature includes a neck portion selectively received by the at least one aperture to couple the connection feature with the tab. The at least one shoulder restricts the neck portion from being inserted into the at least one aperture from vertically beneath the tab. A body portion is coupled with the neck portion. The body portion defines a body aperture for retaining wiring. The at least one shoulder restricts the neck portion from being inserted into the at least one aperture from vertically beneath the tab.

### FIELD OF THE INVENTION

The present disclosure relates generally to refrigerator appliances, more particularly to a harness for refrigerator appliances.

### BACKGROUND OF THE INVENTION

Refrigerators typically have wires or conduits that extend between a liner and a case of the refrigerator. Known systems may face issues related to condensation building on the wires.

Refrigerator appliances typically have a case, or cabinet, that houses storage and refrigeration components like the liner, condenser, evaporator, and the like. Typical refrigerator appliances are equipped with at least one electrical component like condenser, a condenser fan, an evaporator, a light, and more. Additionally, refrigerator appliances may also be equipped with water conduits or tubing to form ice or deliver water. As a result of cooling an inside of the cabinet of the refrigerator appliances, condensation may accumulate between the liner and the cabinet. Furthermore, condensation may collect around wires and pool near junctions, or inputs for example, of the wires. Pooling of water near junctions of the wires may cause undesirable effects like short circuiting.

Accordingly, improvements to placement of wires and the like for refrigerator appliances would be desirable. Specifically, improvements that reduce condensation collection on wires would be desirable.

### BRIEF DESCRIPTION OF THE INVENTION

Aspects and advantages of the invention will be set forth in part in the following description, may be apparent from the description, or may be learned through practice of the invention.

In one exemplary aspect, a refrigerator appliance a refrigerator appliance includes a cabinet that has a top portion and a conduit coupled with the cabinet. The conduit extends along the top portion of the cabinet. A liner is disposed within the cabinet. A harness assembly includes a tab coupled with the conduit and extends therefrom. The tab defines at least one aperture. A connection feature includes a neck portion selectively received by the at least one aperture to couple the connection feature with the tab and a body portion coupled with the neck portion. The body portion defines a body aperture for retaining wiring.

In another example aspect, a harness assembly is for a refrigerator that defines a vertical direction, a lateral direction, and a transverse direction. The refrigerator appliance has a cabinet that has a top portion and a bottom portion. The refrigerator has a conduit coupled with the cabinet. The harness assembly includes a tab coupled with the conduit and extends therefrom. The tab includes at least one shoulder that extends vertically down from the tab. A connection feature includes a neck portion selectively received by the at least one aperture to couple the connection feature with the tab. The at least one shoulder restricts the neck portion from being inserted into the at least one aperture from vertically beneath the tab. A body portion is coupled with the neck portion. The body portion defines a body aperture for retaining wiring. The at least one shoulder restricts the neck portion from being inserted into the at least one aperture from vertically beneath the tab.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a refrigerator appliance according to an exemplary embodiment of the present subject matter;

FIG. 2 provides a perspective view of the refrigerator appliance of FIG. 1;

FIG. 3 provides a front view of the refrigerator appliance of FIG. 1 with doors thereof in an open position;

FIG. 4 provides an x-ray view of a conduit and a harness assembly of the refrigerator appliance of FIG. 1.

FIG. 5 provides a zoomed-in exploded view of the conduit and the harness assembly of the refrigerator appliance of FIG. 4.

FIG. 6 provides a zoomed-in view of the conduit and the harness assembly of the refrigerator appliance of FIG. 4.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

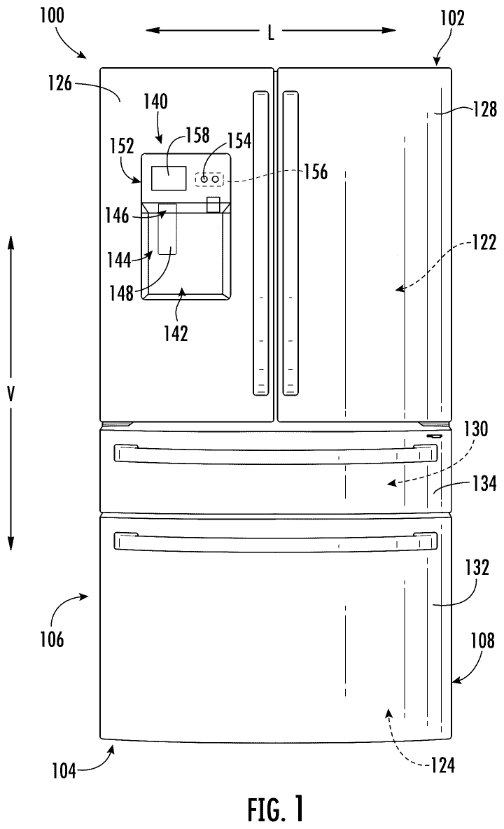

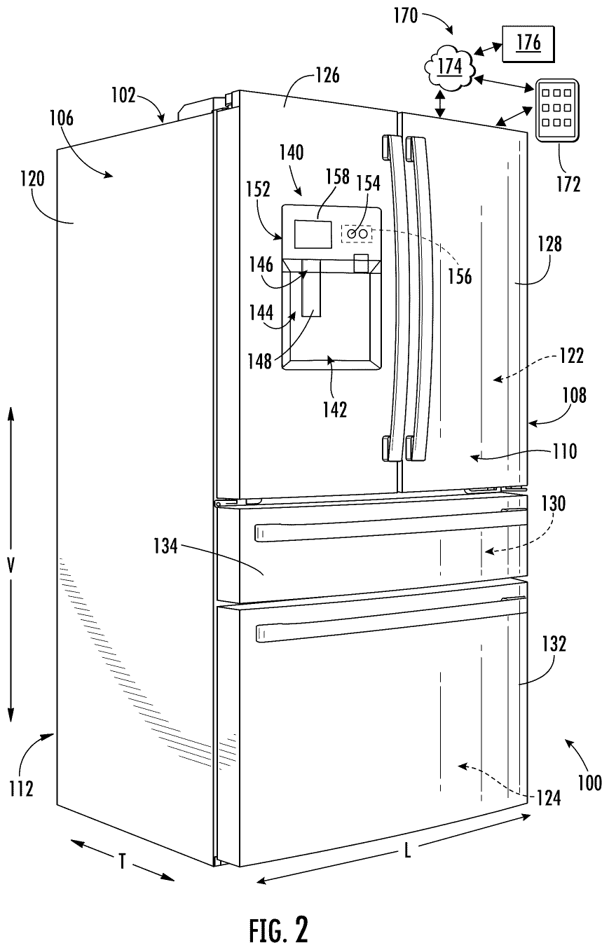

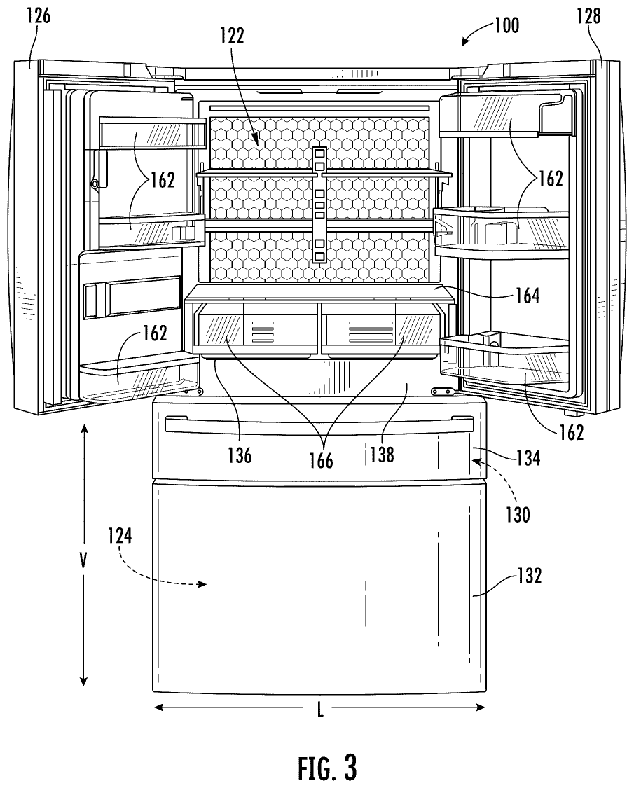

Turning to the figures, FIG. 1 is a front view of an exemplary embodiment of a refrigerator appliance 100. FIG. 2 is a perspective view of the refrigerator appliance 100. FIG. 3 is a front view of the refrigerator appliance 100 with fresh food doors, left door 126 and right door 128 thereof, in an open position. Refrigerator appliance 100 extends between a top 102 and a bottom 104 along a vertical direction V. Refrigerator appliance 100 also extends between a first (left) side 106 and a second (right) side 108 along a lateral direction L. As shown in FIG. 2, a transverse direction T may additionally be defined perpendicular to the vertical and lateral directions V and L. Refrigerator appliance 100 extends along the transverse direction T between a front portion 110 and a back portion 112. The vertical, lateral, and transverse directions illustrated throughout the figures are mutually perpendicular.

Refrigerator appliance 100 includes a housing or cabinet 120 defining a fresh food chamber 122 and a lower freezer chamber or frozen food storage chamber 124 arranged below the fresh food chamber 122 along the vertical direction V. In some embodiments, an auxiliary food storage chamber 130 may be positioned between the fresh food storage chamber 122 and the frozen food storage chamber 124, e.g., along the vertical direction V. Because the frozen food storage chamber 124 is positioned below the fresh food storage chamber 122, refrigerator appliance 100 is generally referred to as a bottom mount refrigerator. In the exemplary embodiment, cabinet 120 also defines a mechanical compartment (not shown) for receipt of a sealed cooling system (not shown). Using the teachings disclosed herein, one of skill in the art will understand that the present invention can be used with other types of refrigerators (e.g., single door refrigerators or side-by-sides) as well. Consequently, the description set forth herein is for illustrative purposes only and is not intended to limit the invention in any aspect.

Refrigerator doors 126, 128 are each rotatably hinged to an edge of cabinet 120 for accessing fresh food chamber 122. As illustrated, left door 126 is hinged to an edge of first (left) side wall 178 and right door 128 is hinged to second (right) side wall 180. It should be noted that while two doors 128 in a “French door” configuration are illustrated, any suitable arrangement of doors utilizing one, two, or more doors is within the scope and spirit of the present disclosure. Refrigerator doors 126, 128, when in the closed position of FIG. 1, cooperate with the top wall 182, bottom wall 184, first side wall 178, second side wall 180 and back wall 186 to substantially seal the fresh food storage compartment 122. A freezer door 132 is arranged below refrigerator doors 126, 128 for accessing frozen food chamber 124. In the exemplary embodiment, freezer door 132 is coupled to a freezer drawer (not shown) slidably mounted within frozen food chamber 124. An auxiliary food storage door 134 may be coupled to an auxiliary drawer (not shown) which is slidably mounted within the auxiliary food storage chamber 130.

Operation of the refrigerator appliance 100 can be regulated by a controller 156 that is operatively coupled to at least a control panel 152. Control panel 152 provides user input devices 154 for user manipulation of the operation of refrigerator appliance 100 to modify environmental conditions therein, such as temperature selections, etc. In response to user manipulation of the user input devices 154, the controller 156 operates various components of the refrigerator appliance 100. Operation of the refrigerator appliance 100 can be regulated by the controller 156, e.g., controller 156 may regulate operation of various components of the refrigerator appliance 100 in response to programming and/or user manipulation of the user input devices 154.

The controller 156 may include a memory and one or more microprocessors, CPUs or the like, such as general or special purpose microprocessors operable to execute programming instructions or micro-control code associated with operation of refrigerator appliance 100. The memory may represent random access memory such as DRAM, or read only memory such as ROM or FLASH. In one embodiment, the processor executes programming instructions stored in memory. The memory may be a separate component from the processor or may be included onboard within the processor. It should be noted that controllers 156 as disclosed herein are capable of and may be operable to perform any methods of operating the refrigerator appliance 100 and associated method steps as disclosed herein. As such, controller 156 may be in operable communication with all systems of refrigerator appliance 100, at least control panel 152, display 158, and control and operating systems (not shown) for the fresh food storage chamber 122.

The controller 156 may be positioned in a variety of locations throughout refrigerator appliance 100. In the illustrated embodiment, the controller 156 may be located within the door 126. In such an embodiment, input/output (“I/O”) signals may be routed between the controller and various operational components of refrigerator appliance 100. In one embodiment, the control panel 152 may represent a general purpose I/O (“GPIO”) device or functional block. In one embodiment, the control panel 152 may include user input devices 154, such as one or more of a variety of electrical, mechanical or electro-mechanical input devices including rotary dials, push buttons, and touch pads. The control panel 152 may include a display 158 component, such as a digital or analog display device designed to provide operational feedback to a user by displaying graphic images or textural messages. For example, the control panel 152 may include a touchscreen providing both input and display functionality. The control panel 152 may be in communication with the controller 156 via one or more signal lines or shared communication busses that may include wiring 206, for example.

With continued reference to FIG. 1, the refrigerator appliance 100 may include a dispensing assembly 140. Dispensing assembly 140 is generally configured for dispensing liquid water and/or ice. Although an example dispensing assembly 140 is illustrated and described herein, it should be appreciated that variations and modifications may be made to dispensing assembly 140 while remaining within the present subject matter.

Dispensing assembly 140 and its various components may be positioned at least in part within a dispenser recess 142 defined on one of refrigerator doors 128. In this regard, dispenser recess 142 is defined on a front side 110 of refrigerator appliance 100 such that a user may operate dispensing assembly 140 without opening refrigerator door 128. In addition, dispenser recess 142 is positioned at a predetermined elevation convenient for a user to access ice and enabling the user to access ice without the need to bend-over. In the exemplary embodiment, dispenser recess 142 is positioned at a level that approximates the chest level of a user.

Dispensing assembly 140 includes an ice dispenser 144 including a discharging outlet 146 for discharging ice from dispensing assembly 140. An actuating mechanism 148, shown as a paddle, is mounted below discharging outlet 146 for operating ice or water dispenser 144. In alternative exemplary embodiments, any suitable actuating mechanism may be used to operate ice dispenser 144. For example, ice dispenser 144 can include a sensor (such as an ultrasonic sensor) or a button rather than the paddle. Discharging outlet 146 and actuating mechanism 148 are an external part of ice dispenser 144 and are mounted in dispenser recess 142.

The control panel 152 is provided for controlling the mode of operation. For example, control panel 152 includes one or more selector inputs 154, such as knobs, buttons, touchscreen interfaces, etc., such as a water dispensing button and an ice-dispensing button, for selecting a desired mode of operation such as crushed or non-crushed ice. In addition, inputs 154 may be used to specify a fill volume or method of operating dispensing assembly 140. In this regard, inputs 154 may be in communication with the processing device or controller 156. Signals generated in controller 156 operate refrigerator appliance 100 and dispensing assembly 140 in response to selector inputs 154. Additionally, a display 158, such as an indicator light or a screen, may be provided on control panel 152. Display 158 may be in communication with controller 156, and may display information in response to signals from controller 156.

As used herein, “processing device” or “controller” may refer to one or more microprocessors or semiconductor devices and is not restricted necessarily to a single element. The processing device can be programmed to operate refrigerator appliance 100 (as is generally described above), dispensing assembly 140, and other components of refrigerator appliance 100.

Referring to FIG. 2, a schematic diagram of an external communication system 170 will be described according to an exemplary embodiment of the present subject matter. In general, external communication system 170 is configured for permitting interaction, data transfer, and other communications between refrigerator appliance 100 and one or more external devices. For example, this communication may be used to provide and receive operating parameters, user instructions or notifications, performance characteristics, user preferences, or any other suitable information for improved performance of refrigerator appliance 100. In addition, it should be appreciated that external communication system 170 may be used to transfer data or other information to improve performance of one or more external devices or appliances and/or improve user interaction with such devices.

For example, external communication system 170 permits controller 156 of refrigerator appliance 100 to communicate with a separate device external to appliance 100, referred to generally herein as an external device 172. As described in more detail below, these communications may be facilitated using a wired or wireless connection, such as via a network 174. In general, external device 172 may be any suitable device separate from appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control refrigerator appliance 100, etc. In addition, external device 172 and remote server 176 may communicate with refrigerator appliance 100 to communicate similar information.

In general, communication between refrigerator appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

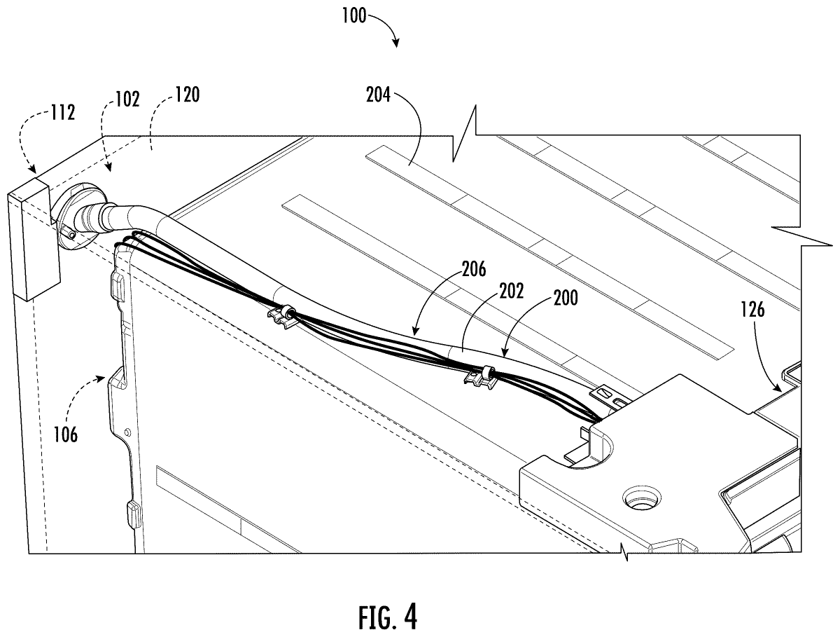

As may be seen in FIG. 3, a plurality of food storage elements, such as bins 162, shelves 164, and drawers 166 are disposed within the fresh food storage chamber 122. As will be described in more detail below, the drawers 166 may be configured for storing produce, i.e., fruits and vegetables. Thus, the drawers 166 may also be referred to as produce drawers 166 or as a vegetable drawer 166 or a fruit drawer 166. For example, in some embodiments, the refrigerator appliance may include two drawers 166, e.g., as illustrated in FIG. 3. As may be seen in FIG. 4, drawer glides (not labeled) may be provided to facilitate sliding of the drawers 166 into and out of the fresh food storage chamber 122. The drawer glides are typically used in pairs to at least support the drawer 166 for sliding without any support at the bottom of the drawer.

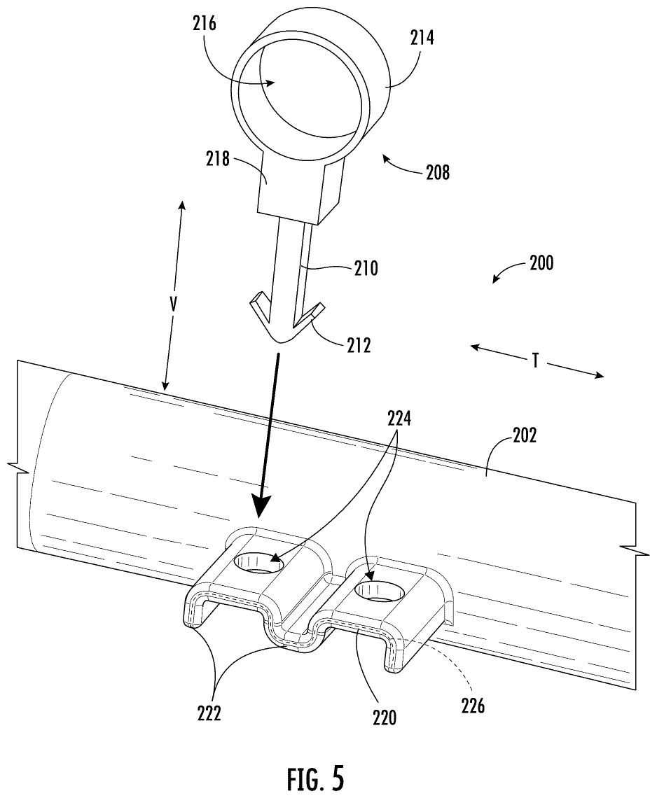

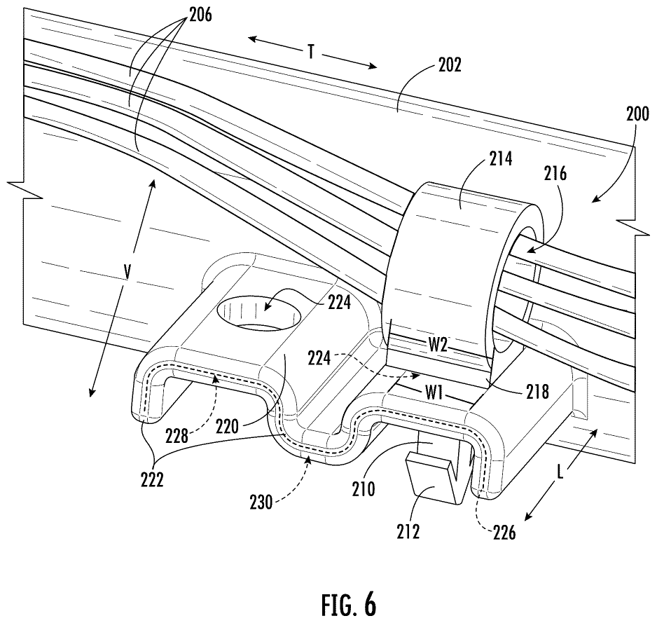

With reference to FIGS. 4 through 6, the refrigerator appliance 100 includes a liner 204 coupled with and disposed within the cabinet 120. The liner 204 may be coupled with the cabinet 120 at the front side 110. The liner 204 is spaced from the cabinet 120 at the back portion 112, the top portion 102, the first side 106, and the second side 108 (not shown). The refrigerator appliance 100 includes a conduit 202 coupled with the cabinet 120. The conduit 202 may supply water from a municipal water supply (not shown) to the dispenser assembly 140, for example. Additionally, or alternatively, the conduit 202 may supply water to an icemaker (not shown). The conduit 202 extends between the liner 204 and the cabinet 120. Additionally, or alternatively, the conduit 202 may extend along the top portion 102 of the cabinet 120. In operation, the refrigerator appliance 100 may generate heat. Due to heat rising from convection, the top portion 102 may be warmer than other components of the refrigerator appliance 100 including, for example, the liner 204. Additionally, or alternatively, the conduit 202 may extend transversely along the top portion 102 between the cabinet 120 and the liner 204.

With continued reference to FIGS. 4 through 6, the refrigerator appliance 100 includes a harness assembly 200 generally coupled with the conduit 202. The harness assembly 200 includes a tab 220 specifically coupled with the conduit 202. Additionally, or alternatively, the tab 220 may be directly coupled with the conduit 202 via welding, for example. Additionally, or alternatively, the tab 220 and the conduit 202 may be integrally formed from a single unitary piece. The tab 220 may extend laterally from the conduit 202. The tab 220 defines at least one aperture 224. As illustrated in the examples of the figures, the tab 220 defines two apertures 224. The tab 220 defining multiple apertures 224 may allow an assembler of the refrigerator appliance 100 to assemble the harness assembly 200 if there is insufficient slack in wiring 206, for example, as is described in more detail below. The tab 220 further includes at least one shoulder 222 extending vertically down toward the liner 204 away from the top portion 102 of the cabinet 120. In other words, the tab 220 may be saddle-shaped. Additionally, or alternatively, the tab 220 may have a sinusoidal profile 226 along a vertical-transverse plane. As shown in the examples of the figures, the tab 220 having the sinusoidal profile 226 may include at least one peak 228 and at least one valley 230. For example, the at least one valley 230 may be between two apertures 224, and the at least one peak 228 may be at the at least one aperture 224.

With even further reference to FIGS. 4 through 6, the harness assembly 200 includes a connection feature 208 selectively and generally coupled with the tab 220. The connection feature 208 includes a neck portion 210 selectively and specifically coupled with the tab 220. The neck portion 210 is selectively received by the at least one aperture 224 of the tab 220. For example, the neck portion 210 may be received by the at least one aperture 224 such that the neck 210 extends vertically down into the aperture 224. The aperture 224 of the tab 220 that receives the neck portion 210 restricts the connection feature 208 from moving in the lateral direction L and the transverse direction T. The connection feature 208 may further include a clip 212 coupled with the neck portion 210. The clip 212 may selectively pass through the aperture 224 and restrict, or prevent, the connection feature 208 from being removed from the aperture 224. For example, the clip 212 may flex to be inserted through the aperture 224 then rebound to restrict the connection feature 208 from being removed. The clip 212 may also be referred to as a barb, for example.

The connection feature 208 further includes a body 214 coupled with the neck portion 210 opposite the clip 212. The body 214 may include a stopping feature 218 that selectively engages with the tab 220 to restrict the connection feature 208 from moving through the aperture 224. In other words, the clip 212 and the stopping feature 218 may restrict the connection feature 208 from moving in the vertical direction V by engaging with the tab 220. More specifically, the clip 212 and the stopping feature 218 may at least partially restrict the connection feature 208 from being removed from the aperture 224 by engaging with the tab 220. For example, the clip 212 and the stopping feature 218 may be larger than the aperture 224 such that removal would cause deformation of at least one of the tab 220 or the connection feature 208.

Additionally, or alternatively, the body 214 may engage with the at least one shoulder 222 of the tab 220 to restrict the connection feature 208 from being inserted into the aperture 224 vertically upward. In other words, the at least one shoulder 222 and the stopping feature 218 may prevent the connection feature 208 from being coupled with the tab 220 in such a way that would place the wiring vertically below the tab 220 instead of vertically above the tab 220, as illustrated. Additionally, or alternatively, the at least one shoulder 222 of the tab 220 may be engaged, or contacted, by the body 214 of the connection feature 208 to prevent the neck portion 210, and the clip 212 from passing through the aperture 224 in a vertically upward direction. For example, a first transverse width W1 of the peak 228 of the sinusoidal profile 226 of the tab 220 may be less than a second transverse width W2 of the body 214. The shoulder 222 of the tab 220 and the body 214 of the connection feature 208 ensure the connection feature 208 couples with the tab 220 by inserting the neck portion 210 vertically downward into the aperture 224.

The connection feature 208 coupled with the tab 220 where the body 214 is vertically above the tab 220, proximally adjacent to the top portion 102, and the neck portion 210, and therefore the clip 212, is vertically below the tab 220, distal the top portion 102, allows the wiring 206 to be positioned adjacent to the top portion 102 of the cabinet 120. As mentioned above, in operation the top portion 102 of the cabinet 120 may be warmer in temperature than the liner 204, for example. Placing the wiring 206 adjacent to the top portion 102 which may be warmer may restrict condensation from accumulating on the wiring 206 due to, for example, an increased rate of evaporation.

The body 214 of the connection feature 208 defines a body aperture 216 for retaining the wiring 206. The body aperture 216 of the connection feature 208 coupled with the tab 220 may extend generally parallel with, or to, the conduit 202. For example, the body aperture 216 may extend such that the wiring 206 extends generally transversely and parallel to the conduit 202. Additionally, or alternatively, the body 214 may statically couple with the wiring 206 in the body aperture 216 via an adhesive (e.g., tape). The tab 220 defining multiple apertures 224 may allow the assembler of the harness assembly 200 to choose an aperture of the multiple apertures 224 that provides more slack to the wiring 206.

Advantageously, the harness assembly described herein allows for wiring to be placed closer to a warmer region of a refrigerator appliance to prevent, or restrict, accumulation of condensation on the wiring. If condensation is allowed to accumulate on the wiring, the condensation may pool at junction or inlets of the wiring, which may cause shorting out of electrical systems of the refrigerator appliance. The harness assembly described herein diminishes this problem while also allowing wiring to be more elegantly and securely coupled within a cabinet of the refrigerator appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A refrigerator appliance defining a vertical direction, a lateral direction, and a transverse direction, the vertical, lateral, and transverse directions being mutually perpendicular, the refrigerator appliance comprising:
a cabinet;
a conduit coupled with the cabinet;
a liner disposed within the cabinet;
a harness assembly comprising:
a tab coupled with the conduit and extending therefrom, wherein the tab defines at least one aperture, and wherein the tab includes at least one shoulder extending vertically down from the tab; and
a connection feature comprising:
a neck portion selectively received by the at least one aperture to couple the connection feature with the tab, wherein the at least one shoulder restricts the neck portion from being inserted into the at least one aperture from vertically beneath the tab; and
a body coupled with the neck portion, the body defining a body aperture for retaining wiring.

2. The refrigerator appliance of claim 1, wherein the connection feature further comprises a clip coupled with the neck portion, wherein the clip retains the connection feature in the at least one aperture of the tab.

3. The refrigerator appliance of claim 2, wherein the body and the clip retain the connection feature in the at least one aperture.

4. The refrigerator appliance of claim 3, wherein the body and the clip retain the connection feature in the at least one aperture along the vertical direction, and wherein the at least one aperture that receives the neck portion retains the connection feature along the transverse direction and the lateral direction.

5. The refrigerator appliance of claim 1, wherein the cabinet comprises a top portion, and wherein the top portion is operably warmer than the liner.

6. The refrigerator appliance of claim 5, wherein the conduit extends along the top portion of the cabinet such that the harness assembly retains the wiring adjacent to the top portion to diminish condensation.

7. The refrigerator appliance of claim 5, wherein the body of the connection feature coupled with the tab is proximal to the top portion of the cabinet, and wherein the neck portion of the connection feature coupled with the tab is distal the top portion of the cabinet.

8. The refrigerator appliance of claim 1, wherein the tab is saddle-shaped.

9. The refrigerator appliance of claim 1, wherein tab and the conduit are an integral unitarily formed single piece.

10. The refrigerator appliance of claim 1, wherein the body aperture of the body of the connection feature coupled with the tab extends generally parallel with the conduit.

11. A harness assembly for a refrigerator appliance defining a vertical direction, a lateral direction, and a transverse direction, the refrigerator appliance having a cabinet having a top portion and a bottom portion, and wherein the refrigerator has a conduit coupled with the cabinet, the harness assembly comprising:
a tab coupled with the conduit and extending therefrom, wherein the tab defines at least one aperture and wherein the tab includes at least one shoulder extending vertically down from the tab; and
a connection feature comprising:
a neck portion selectively received by the at least one aperture to couple the connection feature with the tab, wherein the at least one shoulder restricts the neck portion from being inserted into the at least one aperture from vertically beneath the tab; and
a body coupled with the neck portion, the body defining a body aperture for retaining wiring.

12. The harness assembly of claim 11, wherein the connection feature further comprises a clip coupled with the neck portion, wherein the clip retains the connection feature in the at least one aperture of the tab.

13. The harness assembly of claim 12, wherein the body and the clip retain the connection feature in the at least one aperture.

14. The harness assembly of claim 13, wherein the body and the clip retain the connection feature in the at least one aperture along the vertical direction, and wherein the at least one aperture that receives the neck portion retains the connection feature along the transverse direction and the lateral direction.

15. The harness assembly of claim 11, wherein the top portion of the cabinet is operably warmer than the bottom portion, and wherein the conduit extends along the top portion of the cabinet such that the harness assembly retains the wiring adjacent to the top portion to diminish condensation.

16. The harness assembly of claim 15, wherein the body of the connection feature coupled with the tab is proximal to the top portion of the cabinet, and wherein the neck portion of the connection feature coupled with the tab is distal the top portion of the cabinet.

17. The harness assembly of claim 11, wherein the body further comprises a stopping feature operably engaged with the tab, and wherein the stopping feature at least partially restricts the connection feature from moving relative to the at least one aperture.

18. The harness assembly of claim 11, wherein the tab is saddle-shaped.

19. The harness assembly of claim 11, wherein tab and the conduit are an integral unitarily formed single piece.

20. The harness assembly of claim 11, wherein the body aperture of the body of the connection feature coupled with the tab extends generally parallel to the conduit.
